(19) United States
(12) Patent Application Publication
(10) Pub. No.: US 2005/0122546 A1
(43) Pub. Date: Jun. 9, 2005

(54) Image processing mechanism for image enhancement and halftone processing

(76) Inventors: Hsiao-Yu Han, Hsinchu (TW); Jane Chang, Hsinchu (TW); Jessen Chen, Hsinchu (TW); Yu-Chu Huang, Hsinchu (TW); Shyh-Hsing Wang, Hsinchu (TW); Yao-Wen Huang, Hsinchu (TW)

Correspondence Address: BIRCH STEWART KOLASCH & BIRCH, PO BOX 747, FALLS CHURCH, VA, 22040-0747, US

(21) Appl. No.: 10/819,298

(22) Filed: Apr. 7, 2004

(30) Foreign Application Priority Data
Dec. 5, 2003 (TW) 092134443

(51) Int. Cl. H04N 1/405; H04N 1/409; G06T 5/00

(52) U.S. Cl. 358/3.03; 358/3.27; 358/3.06; 382/260

(57) ABSTRACT

An image processing mechanism combines the halftone method and image enhancement technique for processing halftone and improving image performance. The mechanism includes an image input module, an image enhancement module and a halftone module. The image input module sends the original image data to the image enhancement module to enhance the image by filtering. The halftone module processes the enhanced image data by the algorithm of error diffusion. It combines two different processes into one mechanism to simplify the hardware architecture and to decrease the usage of memory.

### BACKGROUND OF THE INVENTION

1. Field of Invention

The invention relates to an image processing mechanism for image output devices and, in particular, to an image processing mechanism that simultaneously combines halftone and image enhancement techniques.

2. Related Art

Generally speaking, the digital images displayed on computers are composed of the red (R), green (G), and blue (B) colors in different proportions. Taking 24-bit images as an example, the R, G, and B colors are represented in 8 bits respectively. In other words, the color level in each color ranges from 0 to 255. For example, if the levels of R, G and B are all zero, the color is black. If the levels of R, G and B equal to one, the color is white. However, problems occur when the digital image is to be output from the computer. This is because many printing and display devices can only produce binary images. Therefore, in order to conform to the characteristics of output devices, images with many color levels have to be converted into binary images. This conversion method is called halftone.

The halftone method utilizes the illusion of human eyes toward shades to produce the feeling of multiple color levels. Take a printer as an example and suppose a small square on paper is a unit area. Different filling levels inside the unit correspond to different color levels. If an observer watches this square from a distance, he or she will not notice the variation of the brightness inside the square but treats the square as a whole. What the observer sees is the average brightness of the square.

According to the number of points of the original image needed for one pixel of halftone processing, the halftone processing generally includes two methods: the single-point processing and neighboring-point processing. For the single-point processing method, the halftone output is usually obtained by sending each pixel of the original image through a predetermined mask. A representative example is the dither method. For the neighboring-point method, the halftone output cannot be obtained from a simple pixel comparison but by filtering. A representative is the algorithm of error diffusion. Since the error diffusion method renders better color-level results, this method is often used to obtain high-quality halftone image output. Nonetheless, a drawback of this method is that it involves complicated computation. For a single pixel of halftone image, several multiplications and additions involving its neighboring points are needed.

The purpose of halftone processing for a color image is to comply with the characteristics of an output device. As the halftone processed image is reduced in its color levels, the output quality is often not as good as the original one. If the image quality of the original one is very poor, e.g. image with noises or blurred image, the output halftone image will be even worse. To solve this problem, one usually performs image enhancement to the original image before halftone processing. In this case, the algorithmic structure and computational complexity are increased, and the memory requirement is more.

On the other hand, both multi-function peripherals (MFP) and photo printers make use of the halftone technique. In the copy procedure of the MFP, a color document can be directly scanned and printed. This process is completely independent, without being processed by the computer. If there does not exist any mechanisms to enhance the image in MFP, the output quality will be solely determined by the original document. Once the original document has some defects, the printing output will also have defects. Similar situations also happen to the photo printer. General photo printers have devices for plugging in a memory card. There are many image files that maybe saved or shot by users in the memory card. The user selects an image from memory card to print. Since this procedure does not involve with computer processing either, the output quality will be determined by the original image. In these cases, the output quality improvement has to be done at the input end. As a result, many different techniques can be applied to improve the quality.

A solution is provided by the U.S. Pat. No. 6,424,747. It provides a smooth circuit, which selects an appropriate filter from a filter storage unit. Corresponding values in a color conversion table are then used for the filter to smooth the image. However, this method directly changes the color of the image, and this may affect the overall image quality. In the U.S. Pat. No. 6,201,613, halftone processed images are passed through a low-pass filter to achieve the smooth effect. Since this method smoothes the images that have been halftone processed, its effects are thus very limited. The U.S. Pat. No. 6,061,145 also performs the smooth task on halftone processed images. It first detects the sharp patterns in a halftone image. Then, these sharp patterns are replaced by predetermined smooth patterns. This method requires at least two steps: detection and replacement. In detection part, since the whole image has to be scanned pixel by pixel, a lot of time is wasted. The more predefined sharp patterns there are, the longer it takes to detect them. Therefore, it is very impractical. In the U.S. Pat. No. 5,757,976, the halftone is performed by error diffusion. In this method, a filter control circuit is used to select the error diffusion filter according to the gray values in pre-segmented region of the image. However, the change of values in the error filters only affects the noises and repeated patterns generated by the halftone process. The quality of the original image almost is not improved.

### SUMMARY OF THE INVENTION

In view of the foregoing, the invention provides an image processing mechanism that combines image enhancement and halftone techniques to achieve the goal of halftone processing and image enhancement. Not only does it have a simple structure, the required memory is also smaller.

The disclosed image processing mechanism includes an image input module, an image enhancement module, and a halftone module. The image input module obtains the original image. The image enhancement module directly enhances the original image data and sends it to the halftone module. Since the original image data are directly enhanced before halftone processing, the image quality is greatly enhanced without affecting the original contents. It also simultaneously completes the image enhancement and halftone processing, greatly reducing the usage of memory.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of data processing in a printing machine; and

FIG. 2 is a schematic structural view of the invention.

### DETAILED DESCRIPTION OF THE INVENTION

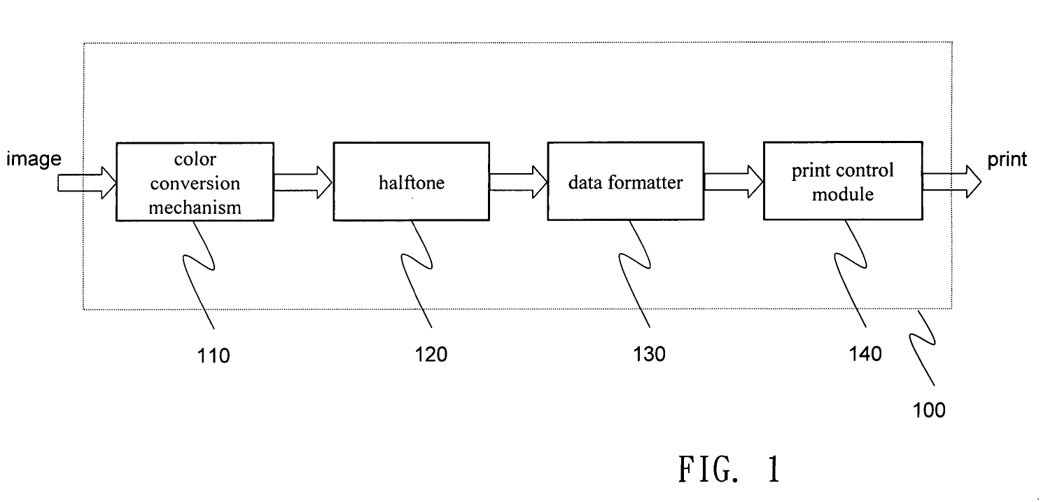

The disclosed image processing mechanism that combines the image enhancement and halftone techniques is mainly applied to image output devices, such as printers and multi-function peripherals (MFP). As shown in FIG. 1, the data processing mechanisms of the printer or MFP 100 include a color conversion mechanism 110, a halftone processing mechanism 120, a data formatter 130, and a print control module 140. The image to be printed exists in the data of three primitive colors: red, green and blue (RGB). First, an image is sent to the color conversion mechanism 110 and gets converted into color coordinates, from the three primitive colors to printing colors. The halftone mechanism 120 transfers a multi-bit image into at least one-bit image color by color. The halftone image is arranged by the data formatter 130 into the format required for printing. Taking an inkjet printer as an example, this step arranges the halftone output image in the format of inkjet nozzles. Finally, the print control module 140 receives printing data and generates dots to perform the image on a medium.

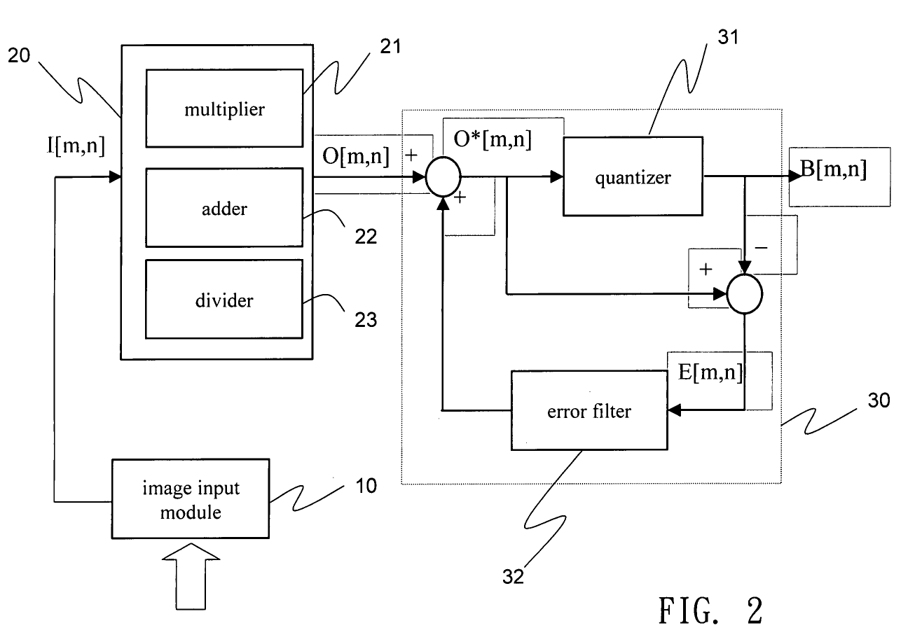

The disclosed image processing mechanism replaces the original halftone processing mechanism 120. As shown in FIG. 2, it contains an image input module 10, an image enhancement module 20, and a halftone module 30. The original image data I[m,n] which are directly sent to the image enhancement module 20 is obtained through image input module 10.

The image enhancement module 20 is mainly in the form of a filter. Its algorithm roughly can be written as:

$$O [ m , n ] = {\sum }_{k , r} I [ m - k , n - r ] \times a [ k , r ]$$

where I[m,n] are the original image data, O[m,n] are the image enhanced data, and a[k,r] are the filters. It can be implemented by smoothing as in the following table

| | | |
|---|---|---|
| 1/9 | 1/9 | 1/9 |
| 1/9 | 1/9 | 1/9 |
| 1/9 | 1/9 | 1/9 |

or by sharpening as in the following table

| | | |
|---|---|---|
| 0 | 1 | 0 |
| 1 | 1 | −1 |
| 0 | −1 | 0 |

No matter which type of filter is used, the letter in the italic font of the filter corresponds to the processed pixel of the original image data. A multiplier 21 multiplies the pixels and its neighboring pixels by predetermined weights (numbers in the tables) to obtain a set of weighted values. An adder 22 accumulates the weighted values of the processed pixel to obtain a sum. Finally, a divider 23 is used to divide the sum by the sum of the predetermined weights, and the image enhanced datum for the pixel being processed is obtained.

After all pixels are processed, the image enhanced data O[m,n] are sent to the halftone module 30. The algorithm is shown as follows:

$$\begin{matrix}O * [ m , n ] = O [ m , n ] + {\sum }_{k , r} E [ m - k , n - r ] \times a [ k , r ] \\ E [ m , n ] = O * [ m , n ] - B [ m , n ] \\ B [ m , n ] = \{ \begin{matrix}1 , O * [ m , n ] \geq \frac{2 ( D - 1 ) - 1}{2 ( D - 1 )} \\ \frac{D - 2}{D - 1} , \frac{2 ( D - 1 ) - 3}{2 ( D - 1 )} \leq O * [ m , n ] < \frac{2 ( D - 1 ) - 1}{2 ( D - 1 )} \\ M \\ \frac{2}{D - 1} , \frac{3}{2 ( D - 1 )} \leq O * [ m , n ] < \frac{5}{2 ( D - 1 )} \\ \frac{1}{D - 1} , \frac{1}{2 ( D - 1 )} \leq O * [ m , n ] < \frac{3}{2 ( D - 1 )} \\ 0 , O * [ m , n ] < \frac{1}{2 ( D - 1 )}\end{matrix}\end{matrix}$$

where the image enhanced data O[m,n] usually ranges between 0 (White) to 1 (Black). B[m,n] are the output from a quantizer 31 and is one of the D values as follows: 0,

$$\frac{1}{D - 1} , \frac{2}{D - 1} ,$$

. . . , 1. The thresholds in the quantizer 31 are fixed at specific values. If the threshold values are equally divided, they are

$$\frac{1}{2 ( D - 1 )} , \frac{3}{2 ( D - 1 )} ,$$

. . . ,

$$\frac{2 ( D - 1 ) - 1}{2 ( D - 1 )} .$$

E[m,n] is error signal after quantization. The value is obtained by taking the difference between the signals before and after quantization. After E[m,n] passes through the error filters 32, correction signals is produced to correct future inputs. O*[m,n] is the corrected signal. a[k,r] are the error filters 32 (the values in the filters are weights of the error signals, and [k,r] refer to the propagations of the error signals).

Combining the above-mentioned algorithms, one obtains:

$$E [ m , n ] = O [ m , n ] - B [ m , n ] + {\sum }_{k , r} E [ m - k , n - r ] \times a [ k , r ]$$

After converting the equation above into the frequency domain, we obtain:
E[z₁,z₂]=[O[z₁,z₂]−B[z₁,z₂]]H[z₁,z₂]

Therefore, we know that this is an all-pole, linear system. Common embodiments of the error filters 32 include the Floyd and Steinberg (see the following table)

| | | |
|---|---|---|
| | * | 7/16 |
| 3/16 | 5/16 | 1/16 |

Jarvis, Judice and Ninke (see the following table)

| | | | | |
|---|---|---|---|---|
| | | * | 7/48 | 5/48 |
| 3/48 | 5/48 | 7/48 | 5/48 | 3/48 |
| 1/48 | 3/48 | 5/48 | 3/48 | 1/48 |

Stucki (see the following table)

| | | | | |
|---|---|---|---|---|
| | | * | 8/42 | 4/42 |
| 2/42 | 4/42 | 8/42 | 4/42 | 2/42 |
| 1/42 | 2/42 | 4/42 | 2/42 | 1/42 |

and Stevenson and Arce (see the following table)

| | | | | | | |
|---|---|---|---|---|---|---|
| | | | * | | 32/200 | |
| 12/200 | | 26/200 | | 30/200 | | 16/200 |
| | 12/200 | | 26/200 | | 12/200 | |
| 5/200 | | 12/200 | | 12/200 | | 5/200 |

where * refers to the pixel to be diffused.

Putting the algorithms of the image enhancement module 20 and the halftone module 30 together, we obtain

$$\begin{matrix}O * [ m , n ] = {\sum }_{p , q} O [ m - p , n - q ] \times a [ p , q ] + {\sum }_{k , r} E [ m - k , n - r ] \times c [ k , r ] \\ E [ m , n ] = O * [ m , n ] - B [ m , n ] \\ B [ m , n ] = \{ \begin{matrix}1 , O * [ m , n ] \geq \frac{2 ( D - 1 ) - 1}{2 ( D - 1 )} \\ \frac{D - 2}{D - 1} , \frac{2 ( D - 1 ) - 3}{2 ( D - 1 )} \leq O * [ m , n ] < \frac{2 ( D - 1 ) - 1}{2 ( D - 1 )} \\ M \\ \frac{2}{D - 1} , \frac{3}{2 ( D - 1 )} \leq O * [ m , n ] < \frac{5}{2 ( D - 1 )} \\ \frac{1}{D - 1} , \frac{1}{2 ( D - 1 )} \leq O * [ m , n ] < \frac{3}{2 ( D - 1 )} \\ 0 , O * [ m , n ] < \frac{1}{2 ( D - 1 )}\end{matrix}\end{matrix}$$

In the following, we use an application example to explain the result of the invention. Suppose each pixel of the image is represented in 8 bits. It means that the image input values vary between 0 and 255 (see the following table)

| | | | | | | | | | | | | | | | | | | | |
|---|---|---|---|---|---|---|---|---|---|---|---|---|---|---|---|---|---|---|---|
| 120 | 101 | 105 | 101 | 96 | 94 | 80 | 72 | 77 | 79 | 84 | 86 | 83 | 72 | 102 | 118 | 131 | 166 | 189 | 186 |
| 110 | 73 | 102 | 121 | 106 | 92 | 88 | 57 | 61 | 130 | 114 | 77 | 138 | 56 | 53 | 88 | 167 | 184 | 143 | 192 |
| 127 | 97 | 107 | 124 | 87 | 80 | 88 | 118 | 132 | 173 | 182 | 120 | 184 | 204 | 162 | 165 | 198 | 162 | 94 | 187 |
| 129 | 120 | 120 | 94 | 84 | 78 | 85 | 140 | 167 | 172 | 206 | 209 | 200 | 192 | 230 | 203 | 192 | 177 | 86 | 182 |
| 183 | 130 | 123 | 87 | 78 | 78 | 72 | 69 | 72 | 76 | 100 | 162 | 112 | 209 | 215 | 200 | 192 | 185 | 105 | 136 |
| 192 | 179 | 108 | 95 | 82 | 75 | 74 | 75 | 76 | 77 | 86 | 108 | 205 | 217 | 202 | 187 | 166 | 188 | 154 | 79 |
| 102 | 203 | 220 | 167 | 80 | 80 | 90 | 67 | 75 | 77 | 85 | 209 | 199 | 211 | 197 | 166 | 92 | 181 | 181 | 107 |
| 87 | 109 | 126 | 190 | 178 | 174 | 168 | 65 | 43 | 80 | 135 | 216 | 191 | 210 | 203 | 206 | 208 | 185 | 167 | 161 |
| 98 | 70 | 105 | 90 | 130 | 121 | 71 | 90 | 111 | 139 | 207 | 210 | 213 | 216 | 188 | 161 | 188 | 184 | 156 | 154 |
| 122 | 62 | 87 | 132 | 150 | 174 | 183 | 178 | 165 | 181 | 217 | 186 | 208 | 186 | 145 | 147 | 169 | 191 | 170 | 156 |
| 108 | 91 | 129 | 112 | 124 | 99 | 72 | 76 | 80 | 213 | 194 | 201 | 186 | 168 | 149 | 157 | 200 | 162 | 59 | 143 |
| 44 | 100 | 185 | 86 | 61 | 56 | 56 | 72 | 138 | 224 | 175 | 203 | 161 | 160 | 151 | 180 | 178 | 62 | 105 | 179 |
| 63 | 83 | 147 | 172 | 70 | 54 | 41 | 121 | 209 | 204 | 201 | 185 | 172 | 163 | 220 | 164 | 52 | 93 | 129 | 143 |
| 80 | 56 | 70 | 152 | 173 | 122 | 167 | 186 | 113 | 112 | 208 | 174 | 180 | 183 | 224 | 178 | 119 | 129 | 116 | 116 |
| 106 | 69 | 62 | 76 | 139 | 186 | 116 | 74 | 65 | 64 | 147 | 156 | 167 | 164 | 166 | 199 | 229 | 166 | 125 | 106 |
| 115 | 103 | 181 | 108 | 161 | 52 | 50 | 62 | 61 | 72 | 116 | 159 | 132 | 121 | 126 | 132 | 163 | 213 | 170 | 117 |
| 112 | 78 | 152 | 206 | 201 | 66 | 41 | 65 | 65 | 80 | 109 | 200 | 159 | 100 | 98 | 115 | 132 | 135 | 132 | 130 |
| 117 | 68 | 65 | 120 | 189 | 174 | 77 | 56 | 72 | 97 | 121 | 149 | 204 | 110 | 43 | 126 | 126 | 133 | 126 | 129 |
| 126 | 102 | 103 | 187 | 127 | 118 | 208 | 165 | 123 | 93 | 116 | 123 | 121 | 49 | 67 | 105 | 102 | 106 | 108 | 143 |
| 118 | 176 | 100 | 153 | 56 | 55 | 53 | 133 | 190 | 89 | 93 | 114 | 118 | 110 | 98 | 83 | 85 | 91 | 95 | 143 |

The halftone output is just one bit: 0 or 1. The threshold in the quantizer is set to be 128. That is, if the input is smaller than 128, the quantizer output is 0; if the input is greater than or equal to 128, the quantizer output is 1. A filter embodiment of the image enhancement is as the following table:

| | | | | |
|---|---|---|---|---|
| 1/13 | 1/13 | 1/13 | 1/13 | 1/13 |
| 1/13 | 1/13 | 1/13 | 1/13 | 1/13 |
| 1/13 | 1/13 | 1/13 | | |

The halftone is achieved by using the error diffusion method. The error weighting filter is the Jarvis, Judice and Ninke filter. The explicit calculation of the pixel (3,3) is

$$\begin{matrix}{O}^{*} [ 3 , 3 ] = \frac{1}{13} \{ O [ 1 , 1 ] + O [ 2 , 1 ] + O [ 3 , 1 ] + O [ 4 , 1 ] + \\ O [ 5 , 1 ] + O [ 1 , 2 ] + O [ 2 , 2 ] + O [ 3 , 2 ] + O [ 4 , 2 ] + \\ O [ 5 , 2 ] + O [ 1 , 3 ] + O [ 2 , 3 ] + O [ 3 , 3 ] \} + E [ 1 , 1 ] + \\ E [ 2 , 1 ] + E [ 3 , 1 ] + E [ 4 , 1 ] + E [ 5 , 1 ] + E [ 1 , 2 ] + \\ E [ 2 , 2 ] + E [ 3 , 2 ] + E [ 4 , 2 ] + E [ 5 , 2 ] + E [ 1 , 3 ] + E [ 2 , 3 ] \\ = \frac{1}{13} \{ 120 + 101 + 105 + 101 + 96 + 110 + 73 + 102 + \\ 121 + 106 + 127 + 97 + 107 \} + ( 120 - 0 ) + ( 119 - 0 ) + \\ ( 135 - 255 ) + ( 96 - 0 ) + ( 98 - 0 ) + ( 132 - 255 ) + \\ ( 78 - 0 ) + ( 119 - 0 ) + ( 173 - 255 ) + ( 142 - 255 ) + \\ ( 142 + 255 ) + ( 101 - 0 ) \\ = 105 + 120 + 119 - 120 + 96 + 98 - 123 + 78 + \\ 119 - 82 - 113 - 113 + 101 \\ = 116 < 128 \\ ∴ B [ 3 , 3 ] = 0\end{matrix}$$

The halftone image data of the whole image are computed and given in the following table.

| | | | | | | | | | | | | | | | | | | | |
|---|---|---|---|---|---|---|---|---|---|---|---|---|---|---|---|---|---|---|---|
| 0 | 0 | 1 | 0 | 0 | 0 | 0 | 0 | 0 | 0 | 0 | 0 | 0 | 0 | 1 | 0 | 1 | 1 | 1 | 1 |
| 1 | 0 | 0 | 1 | 1 | 0 | 1 | 0 | 0 | 1 | 1 | 0 | 1 | 0 | 0 | 0 | 1 | 1 | 0 | 1 |
| 1 | 0 | 0 | 1 | 0 | 0 | 1 | 1 | 0 | 1 | 1 | 0 | 1 | 1 | 0 | 1 | 0 | 0 | 0 | 1 |
| 0 | 1 | 1 | 0 | 0 | 0 | 0 | 0 | 1 | 0 | 0 | 1 | 1 | 0 | 1 | 1 | 1 | 1 | 0 | 1 |
| 1 | 0 | 1 | 0 | 1 | 1 | 0 | 1 | 1 | 0 | 1 | 1 | 0 | 1 | 1 | 1 | 1 | 1 | 0 | 0 |
| 1 | 1 | 0 | 0 | 0 | 1 | 0 | 0 | 0 | 1 | 0 | 1 | 1 | 1 | 0 | 1 | 0 | 1 | 1 | 0 |
| 0 | 1 | 1 | 1 | 0 | 0 | 0 | 0 | 0 | 0 | 0 | 0 | 1 | 1 | 1 | 0 | 1 | 0 | 1 | 0 |
| 0 | 0 | 1 | 1 | 0 | 1 | 1 | 1 | 0 | 1 | 1 | 0 | 1 | 1 | 1 | 1 | 1 | 1 | 1 | 1 |
| 0 | 0 | 1 | 0 | 1 | 0 | 0 | 0 | 1 | 0 | 1 | 1 | 1 | 0 | 0 | 1 | 0 | 0 | 1 | 0 |
| 1 | 0 | 0 | 1 | 0 | 1 | 1 | 0 | 1 | 0 | 1 | 1 | 1 | 1 | 1 | 1 | 1 | 1 | 1 | 0 |
| 0 | 0 | 1 | 0 | 0 | 1 | 1 | 0 | 1 | 1 | 0 | 1 | 1 | 0 | 1 | 1 | 0 | 1 | 0 | 1 |
| 0 | 1 | 1 | 0 | 1 | 0 | 0 | 0 | 1 | 1 | 0 | 1 | 1 | 0 | 0 | 1 | 0 | 0 | 0 | 1 |
| 0 | 0 | 0 | 1 | 0 | 0 | 0 | 1 | 0 | 1 | 1 | 1 | 1 | 1 | 1 | 1 | 1 | 0 | 1 | 1 |
| 0 | 0 | 0 | 1 | 0 | 1 | 1 | 0 | 1 | 0 | 1 | 0 | 0 | 1 | 0 | 1 | 0 | 1 | 0 | 0 |
| 1 | 0 | 1 | 0 | 0 | 1 | 1 | 0 | 1 | 0 | 1 | 1 | 1 | 1 | 0 | 1 | 1 | 0 | 1 | 0 |
| 0 | 1 | 0 | 1 | 1 | 0 | 0 | 0 | 0 | 1 | 0 | 0 | 1 | 1 | 0 | 1 | 1 | 0 | 1 | 1 |
| 0 | 0 | 1 | 0 | 1 | 0 | 0 | 1 | 0 | 0 | 1 | 0 | 0 | 1 | 0 | 1 | 0 | 1 | 0 | 0 |
| 1 | 0 | 1 | 0 | 0 | 1 | 1 | 0 | 0 | 1 | 1 | 0 | 1 | 1 | 0 | 0 | 1 | 1 | 0 | 1 |
| 0 | 0 | 1 | 1 | 0 | 1 | 0 | 0 | 1 | 0 | 0 | 1 | 0 | 1 | 0 | 0 | 1 | 0 | 0 | 1 |
| 1 | 1 | 0 | 1 | 0 | 1 | 0 | 1 | 1 | 0 | 0 | 1 | 0 | 0 | 1 | 0 | 0 | 1 | 0 | 1 |

The computation of a pixel accomplishes both smoothing and halftone in one procedure. The pixels used in the smoothing process are the same as those in the halftone process. The memory only needs to store the pixel values of the 13 pixels in the filter. Thus, the usage of memory is greatly reduced.

Certain variations would be apparent to those skilled in the art, which variations are considered within the spirit and scope of the claimed invention.

1. An image processing mechanism that combines image enhancement and halftone techniques, which comprises:
an image input module, which reads an image and generates original image data;
an image enhancement module, which receives and filters the original image data to output image enhanced data; and
a halftone module, which receives the enhanced image data and performs halftone process by error diffusion to output a halftone image;
wherein the image enhancement module performs image enhancements using the pixels to be error diffused by the halftone module.

2. The image processing mechanism of claim 1, wherein the image enhancement module is based on filter processing.

3. The image processing mechanism of claim 2, wherein the image enhancement module is a smoothing module.

4. The image processing mechanism of claim 2, wherein the image enhancement module is a sharpening module.

5. The image processing mechanism of claim 2, wherein the image enhancement module includes:
a multiplier, which computes the weighted value by multiplying the pixel value of the original image by a predetermined weight of the filter;
an adder, which computes the sum by adding the weighted values of a pixel being processed and its neighboring pixels; and
a divider, which divides the sum by the total weights to obtain the image enhanced datum of the pixel being processed.

6. The image processing mechanism of claim 2, wherein the image enhancement module is a two-dimensional filter.
